(19) United States
(12) Patent Application Publication
(10) Pub. No.: US 2005/0068956 A1
(43) Pub. Date: Mar. 31, 2005

(54) Scalable packet buffer descriptor management in ATM to ethernet bridge gateway

(75) Inventors: Wilson Y. Liao, Belmont, CA (US); Anguo T. Huang, Mountain View, CA (US); Warren N. Lee, Fremont, CA (US)

Correspondence Address: Jung-Hua Kuo;c/o PortfolioIP, P.O. Box 52050, Minneapolis, MN, 55402, US

(73) Assignee: Intel Corporation, A DELAWARE CORPORATION, Santa Clara, CA (US)

(21) Appl. No.: 10/671,068

(22) Filed: Sep. 25, 2003

(51) Int. Cl. H04L 12/28

(52) U.S. Cl. 370/395.1; 370/474; 370/400; 370/412

(57) ABSTRACT

Systems and methods for scalable packet buffer descriptor management in ATM-Ethernet bridge gateways are disclosed. An ATM-Ethernet processor interfacing between an ATM processor and an Ethernet network processor generally includes a packet buffer pointer ring containing ATM processor packet buffer pointers for managing traffic from the Ethernet network processor to the ATM processor, and a packet descriptor ring and a data buffer for managing traffic from the ATM processor to the Ethernet network processor. The packet descriptor ring contains packet descriptors each including an ATM-Ethernet packet buffer memory address in the data buffer. The ATM processor may be in communication with a SONET framer while the Ethernet network processor may be in communication with an Ethernet MAC.

### BACKGROUND

Asynchronous transfer mode (ATM) is a connection-oriented data transport protocol that is used in a wide variety of broadband networks. The ATM protocol segments data into fixed-length units of data called cells. ATM's connection-oriented routing mechanism, in which the ATM connection is set up via signaling, differs from that of other networks. For example, an Ethernet network is a connectionless local area network (LAN). Data in an Ethernet network is sent in the form of variable-sized Ethernet frames or packets. End stations in an Ethernet network are addressed globally and uniquely by a media access control (MAC) address. An Ethernet end station receives all data that is broadcast, and discards the traffic that is not directed to itself or to all or a subset of end stations as specified by the destination MAC address.

The convergence of voice, video, and other applications is providing opportunities for the development of ATM/LAN switching. However, because some network processors are designed to process packets or frames for Ethernet networks, while other network processors are designed to process ATM cells in an ATM network, interoperability can be a problem. Ethernet packets or frames vary in size, while ATM cells are a fixed 53-bytes in size. When customers wish to interface between an ATM network and an Ethernet network, an efficient and effective connection or interface between the ATM processor and the Ethernet processor is needed.

### BRIEF DESCRIPTION OF THE DRAWINGS

In the accompanying drawings, like reference numerals designate like structural elements.

FIG. 1 is a block diagram illustrating an ATM-Ethernet system utilizing an ATM-Ethernet bridge gateway processor.

FIG. 2 illustrates egress packet buffer management functions performed by the ATM-Ethernet bridge gateway processor in the egress direction.

FIG. 3 illustrates ingress packet buffer management functions performed by the ATM-Ethernet bridge gateway processor in the ingress direction.

FIG. 4 is a flowchart illustrating an egress packet buffer management process performed by the ATM-Ethernet bridge gateway processor in the egress direction.

FIG. 5 is a flowchart illustrating an ingress packet buffer management process performed by the ATM-Ethernet bridge gateway processor in the ingress direction.

### DESCRIPTION OF SPECIFIC EMBODIMENTS

Systems and methods for scalable packet buffer descriptor management in ATM-Ethernet bridge gateways are disclosed. It should be appreciated that the present invention can be implemented in numerous ways, including as a process, an apparatus, a system, a device, a method, or a computer readable medium such as a computer readable storage medium or a computer network wherein program instructions are sent over optical or electronic communication lines. Several inventive embodiments of the present invention are described below.

The system generally includes an ATM processor, an Ethernet network processor, and an ATM-Ethernet processor interfacing between the ATM processor and the Ethernet network processor. The ATM-Ethernet processor generally includes a packet buffer pointer ring containing ATM processor packet buffer pointers for managing traffic from the Ethernet network processor to the ATM processor, and a packet descriptor ring and a data buffer for managing traffic from the ATM processor to the Ethernet network processor. The packet descriptor ring contains packet descriptors each including an ATM-Ethernet packet buffer memory address in the data buffer. The ATM processor may be in communication with a SONET framer, while the Ethernet network processor may be in communication with an Ethernet MAC.

The packet buffer pointer ring is preferably hardware-scalable in size. Each packet buffer pointer points to a packet buffer memory location in the memory of the ATM processor. The packet buffer pointer may contain 16 bits, one being a flag to signal to the ATM-Ethernet processor hardware whether the packet buffer pointer is being used and 15 being an address to point to a packet buffer memory location in a memory of the ATM processor. The packet buffer pointer ring and the packet descriptor ring are preferably circular first-in first-out buffers (FIFOs).

A method for managing communication traffic between an Ethernet network processor and an ATM processor generally includes an ATM-Ethernet processor receiving a packet from the network processor for transmission to the ATM processor, fetching a packet buffer pointer from a packet buffer pointer ring of the ATM-Ethernet processor, the packet buffer pointer including a memory address pointing to a packet buffer memory location in a data buffer memory of the ATM processor, and transmitting the fetched packet buffer pointer and the received packet to the ATM processor.

A method for managing communication traffic from an ATM processor to an Ethernet network processor generally includes an ATM-Ethernet processor receiving a packet from the ATM processor for transmission to the network processor, storing the packet in a data buffer of the ATM-Ethernet processor, storing a packet descriptor for the packet in a packet descriptor ring of the ATM-Ethernet processor, the packet descriptor including a pointer to a memory location in the data buffer to which the packet is stored, analyzing the packet descriptor for error, and if error is detected, dropping the packet descriptor and reporting error to the ATM processor, and if no error is detected, fetching the packet from the data buffer of the ATM-Ethernet processor and transmitting the packet to the network processor.

These and other features and advantages will be presented in more detail in the following detailed description and the accompanying figures which illustrate by way of example. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications. Thus, the present invention is to be accorded the widest scope encompassing numerous alternatives, modifications and equivalents consistent with the principles and features disclosed herein. For purpose of clarity, details relating to technical material that is known in the related technical fields have not been described in detail so as not to unnecessarily obscure the discussion herein.

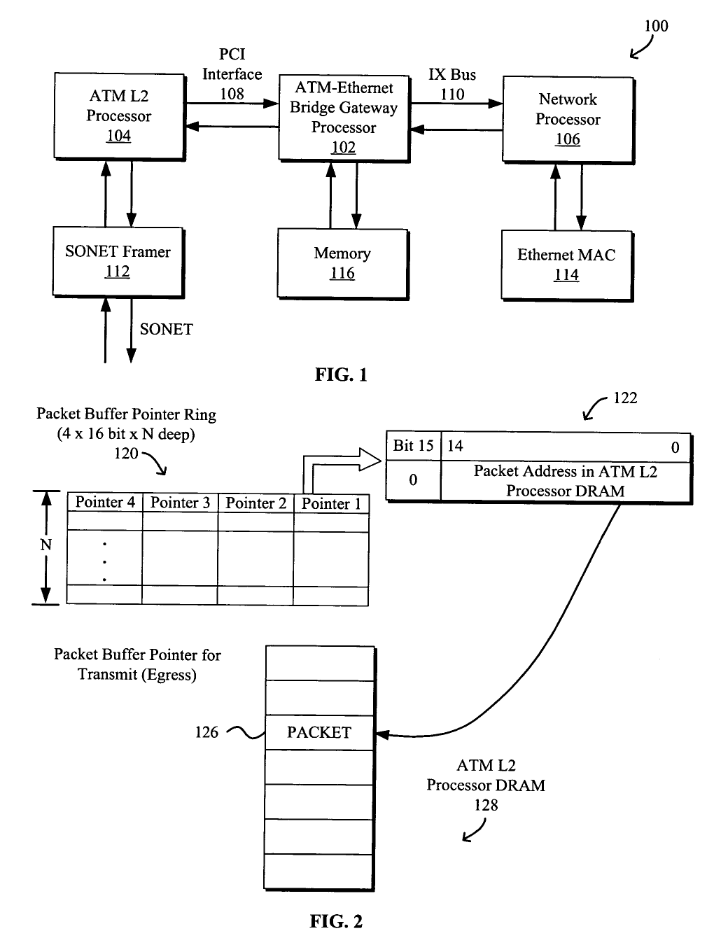

FIG. 1 is a block diagram illustrating an ATM-Ethernet system 100 utilizing an ATM-Ethernet bridge gateway processor 102. As shown, the ATM-Ethernet system 100 generally includes the ATM-Ethernet bridge gateway processor 102 for interfacing between an ATM L2 processor 104, such as Intel Corporation's IXF6402 ATM L2 processor, and a network processor 106, such as Intel Corporation's IXP1200 network processor. The ATM L2 processor 104 interfaces with the ATM-Ethernet bridge gateway processor 102 via, for example, a PCI interface 108. The ATM L2 processor 104 is configured to perform segmentation and reassembly (SAR), a procedure to divide (segment) a message into cells for transmission across an ATM network and to recreate (reassemble) the message from cells. The network processor 106 interfaces with the ATM-Ethernet bridge gateway processor 102 via, for example, an exchange bus 110, such as a 64-bit IX-bus (Intel Exchange bus) used on Intel Corporation's IXP1200 network processor for high-speed I/O. The PCI interface 108 and the exchange bus interface 110 enable data flow from ATM (cell format) to/from Ethernet MAC (packet/frame format).

The ATM L2 processor 104 may be in communication with a SONET framer 112, such as Intel Corporation's IXF6012 OC12 SONET framer, while the network processor 106 may be communication with a Ethernet MAC 114, such as Intel Corporation's IXF1002 Ethernet MAC. Although the ATM-Ethernet bridge gateway processor 102 is shown with a separate memory 116, the memory 116 may be integral with the gateway processor 102.

The ATM-Ethernet bridge gateway processor 102 provides hardware interfaces between the ATM L2 processor 104 and the network processor 106. In addition, the ATM-Ethernet bridge gateway processor 102 also provides a system solution for scalable hardware packet descriptor buffer management to enable seamless cell-to-packet and packet-to-cell conversion in an ATM-Ethernet bridge gateway system 100.

The ATM-Ethernet bridge gateway processor 102 performs various packet buffer management functions. In particular, the ATM-Ethernet bridge gateway processor 102 performs egress packet buffer management functions on the egress side for packets transmitted from the Ethernet MAC 114 to the ATM L2 processor 104 and then to the SONET framer 112 via the network processor 106 and the ATM-Ethernet bridge gateway processor 102. In addition, the ATM-Ethernet bridge gateway processor 102 performs ingress packet buffer management functions on the ingress side for packets transmitted from the ATM L2 processor 104 to the Ethernet MAC 114 via the ATM-Ethernet bridge gateway processor 102 and the network processor 106. The egress and ingress packet buffer management functions performed by the ATM-Ethernet bridge gateway processor 102 will now be described in more detail below.

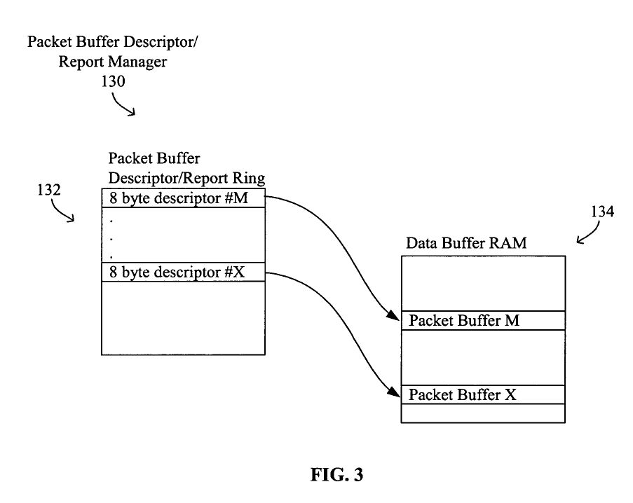

FIG. 2 illustrates the egress packet buffer management functions performed by the ATM-Ethernet bridge gateway processor in connection with packets received by the ATM-Ethernet bridge gateway processor in the egress direction. As shown, the ATM-Ethernet bridge gateway processor manages a scalable hardware packet buffer pointer ring 120. The packet buffer pointer ring 120 is preferably a circular FIFO. The packet buffer pointer ring 120 is preferably 4×16 bit×N deep such that four 16-bit pointers are retrieved with each pointer ring memory access. The packet buffer pointer ring depth N is scalable and can be adjusted to higher or lower depth depending on the performance requirement. On the egress side, the ATM-Ethernet bridge gateway processor automatically fetches a packet buffer pointer 122 from the packet buffer pointer ring 120 and send the packet buffer pointer 122 along with the packet to the ATM L2 processor. ATM L2 processor identifies the memory 126 in its DRAM 128 to which the packet buffer pointer 122 points. The ATM L2 processor then stores the packet in its DRAM at the memory location 126 pointed by the packet buffer pointer 122.

Once the packet is sent from ATM L2 processor, the buffer pointer 122 is placed back in the packet buffer pointer ring 120 to be reused. The packet buffer pointer functionality is managed by the ATM-Ethernet bridge processor hardware and works with both ATM L2 processor and network processor architecture features and functions.

Each packet buffer pointer 122 may include 16 bits including 15 bits for packet address and a bit 15. As shown in FIG. 2, bit 15 is a flag used by the ATM-Ethernet bridge processor hardware and is set to 0 when the packet buffer pointer 122 is being used and is set to 1 once the packet buffer pointer 122 has been used.

FIG. 3 illustrates the ingress packet buffer management functions performed by the ATM-Ethernet bridge gateway processor in connection with packets received by the ATM-Ethernet bridge gateway processor in the ingress direction. To provide scalable hardware packet buffer descriptor management, the ATM-Ethernet bridge gateway processor includes a packet descriptor/report manager 130 that manages a packet descriptor/report ring 132 of the ATM-Ethernet bridge gateway processor. The packet descriptor/report ring 132 is preferably hardware scalable and is preferably implemented as a circular FIFO. Each packet descriptor/report may be 8 bytes and includes a packet buffer pointer that contains an address in a data buffer RAM 134 of the ATM-Ethernet bridge gateway. The data buffer RAM 134 is accessed via the ATM-Ethernet bridge gateway's memory controller, i.e., it is read from and written to by the ATM-Ethernet bridge gateway processor.

In the ingress direction, packet descriptors/reports are stored in the packet descriptor ring 132 of the ATM processor and await processing by the ATM-Ethernet bridge gateway processor. A packet buffer pointer included in each packet descriptor points to a packet buffer memory location in the data buffer RAM 134 of the ATM-Ethernet bridge gateway. The gateway processor analyzes the packet descriptor/report in the packet descriptor ring 132. If there is no error, the gateway processor hands the packet descriptor/report to the direct memory access (DMA) to fetch the packet from the memory location in the data buffer RAM 134 pointed to by the packet buffer pointer in the packet descriptor/report and sends the packet to the network processor. The DMA is preferably implemented in hardware within the ATM-Ethernet bridge gateway processor. Alternatively, if the there is an error, the gateway processor drops the packet descriptor/report and reports to the ATM L2 processor. In either case, the packet 20 descriptor pointers are returned to the ATM L2 processor to be reused.

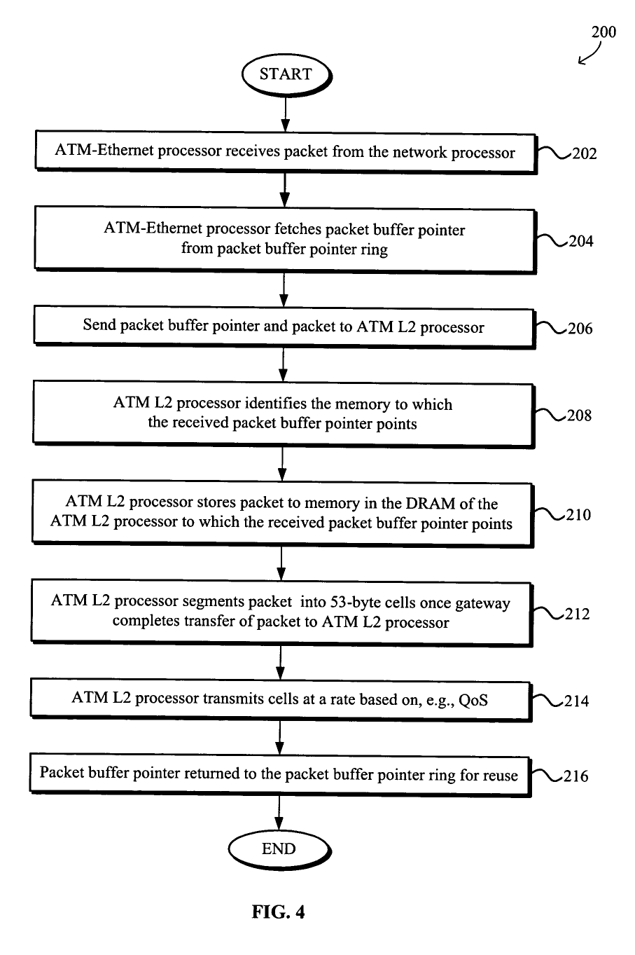

FIG. 4 is a flowchart illustrating an egress packet buffer management process 200 performed by the ATM-Ethernet bridge gateway processor in connection with packets received by the ATM-Ethernet bridge gateway processor in the egress direction. At block 202, the ATM-Ethernet gateway processor receives a packet from the network processor. The ATM-Ethernet gateway processor then fetches a packet buffer pointer from its packet buffer pointer ring at block 204 and sends the packet buffer pointer and the packet to the ATM L2 processor at block 206. The ATM L2 processor identifies the memory in its DRAM to which the received packet buffer pointer points at block 208 and stores the packet to the identified memory in the DRAM at block 210.

At block 212, the ATM L2 processor segments the packet into 53 byte cells once the ATM-Ethernet processor completes transfer of the packet to the AMT L2 processor. At block 214, the ATM L2 processor then transmits the cells at a rate based on, for example, QoS. When the transmission is complete, the ATM L2 processor then returns the packet buffer pointer to the packet buffer pointer ring of the ATM-Ethernet processor for reuse at block 216. For example, bit 15 of the packet buffer pointer may be set to 1 once the packet buffer pointer has been used.

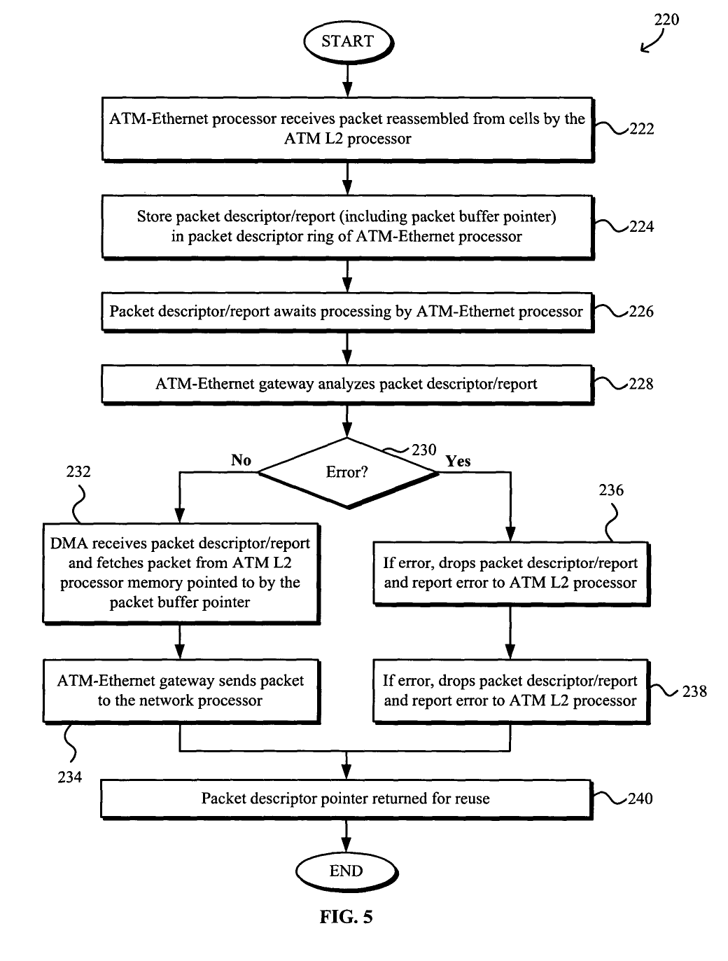

FIG. 5 is a flowchart illustrating an ingress packet buffer management process 220 performed by the ATM-Ethernet bridge gateway processor in connection with packets received by the ATM-Ethernet bridge gateway processor in the ingress direction. At block 222, the ATM-Ethernet gateway processor receives a packet that has been reassembled from cells by the ATM L2 processor. At block 224, the ATM-Ethernet processor stores a packet descriptor/report for the packet in the packet descriptor ring of the ATM-Ethernet processor. The packet descriptor/report includes a packet buffer pointer that points to a place in memory of the ATM-Ethernet processor where the packet is stored. The packet descriptor/report then awaits processing by the ATM-Ethernet processor at block 226. At block 228, the ATM-Ethernet processor analyzes the packet descriptor/report. If no error is detected at decision block 230, then the ATM-Ethernet processor forwards the packet descriptor/report to its DMA which fetches the packet form its memory that is pointed to by the packet buffer pointer in the packet descriptor/report at block 232. The ATM-Ethernet processor then forwards the packet to the network processor at block 234. Alternatively, if an error is detected at decision block 230, then the ATM-Ethernet processor drops the packet descriptor/report at block 236 and reports the error to the ATM L2 processor at block 238. The process 220 then proceeds to block 240 in which the packet descriptor pointer is returned to the packet descriptor/report ring for reuse.

As is evident, the ATM-Ethernet bridge gateway processor provides a method for packet buffer management in both the egress and ingress directions. In particular, the ATM-Ethernet bridge gateway processor provides packet buffer pointer management in the egress direction and packet descriptor/report management in the ingress direction. The ATM-Ethernet bridge gateway processor enables switching between ATM (cell format) to/from Ethernet (packet/frame format).

While various embodiments are described and illustrated herein, it will be appreciated that they are merely illustrative and that modifications can be made to these embodiments. Thus, other embodiments are also within the scope of the following claims.

1. An ATM-Ethernet network system, comprising:
an ATM processor;
an Ethernet network processor; and
an ATM-Ethernet processor interfacing between the ATM processor and the Ethernet network processor, the ATM-Ethernet processor including:
a packet buffer pointer ring for managing traffic from the Ethernet network processor to the ATM processor, the packet buffer pointer ring to contain a plurality of ATM processor packet buffer pointers,
a packet descriptor ring and a data buffer for managing traffic from the ATM processor to the Ethernet network processor, the packet descriptor ring being configured to contain a plurality of packet descriptors each including an ATM-Ethernet packet buffer memory address in the data buffer.

2. The system of claim 1, further comprising SONET framer, wherein the ATM processor is an ATM L2 processor in communication with the SONET framer.

3. The system of claim 1, further comprising an Ethernet MAC in communication with the Ethernet network processor.

4. The system of claim 1, wherein the packet buffer pointer ring is hardware scalable in size.

5. The system of claim 4, wherein the packet buffer pointer ring is a hardware FIFO to contain packet buffer pointers that point to packet buffer memory locations in the memory of the ATM processor.

6. The system of claim 1, wherein each packet buffer pointer contains a flag to signal to the ATM-Ethernet processor hardware whether the packet buffer pointer is being used.

7. The system of claim 1, wherein each packet buffer pointer points to a packet buffer memory location in a memory of the ATM processor.

8. The system of claim 1, wherein each packet buffer pointer contains 16 bits, 15 of which being for a pointer to point to a packet buffer memory location in a memory of the ATM processor.

9. The system of claim 1, wherein the packet buffer pointer ring and the packet descriptor ring are implemented as circular FIFOs.

10. A method for data communication, comprising:
receiving a packet from a network processor by an ATM-Ethernet processor for transmission to an ATM processor;
fetching a packet buffer pointer from a packet buffer pointer ring of the ATM-Ethernet processor, the packet buffer pointer including a memory address pointing to a packet buffer memory location in a data buffer memory of the ATM processor; and
transmitting the fetched packet buffer pointer and the received packet to the ATM processor.

11. The method of claim 10, further comprising:
identifying the memory in the ATM processor to which the memory address in the fetched packet buffer pointer points by the ATM processor;
storing the packet to the memory identified in the ATM processor; and
returning the packet buffer pointer to the ATM-Ethernet processor for reuse.

12. The method of claim 11, wherein said returning is performed after transmitting the data in the packet from the ATM processor to a SONET framer.

13. The method of claim 10, wherein the packet buffer pointer ring of the ATM-Ethernet processor is hardware scalable in size.

14. The method of claim 10, wherein the packet buffer pointer contains a flag to signal to the ATM-Ethernet processor hardware whether the packet buffer pointer is being used.

15. The method of claim 10, wherein the packet buffer pointer ring is implemented in the ATM-Ethernet processor as a circular FIFO.

16. A method for data communication, comprising:
receiving a packet from an ATM processor by an ATM-Ethernet processor for transmission to a network processor;
storing the packet in a data buffer of the ATM-Ethernet processor;
storing a packet descriptor for the packet in a packet descriptor ring of the ATM-Ethernet processor, the packet descriptor including a pointer to a memory location in the data buffer to which the packet is stored;
analyzing the packet descriptor for error; and
if error is detected:
dropping the packet descriptor;
reporting error to the ATM processor;
if no error is detected:
fetching the packet from the data buffer of the ATM-Ethernet processor; and
transmitting the packet to the network processor.

17. The method of claim 16, further comprising returning the packet descriptor to the packet descriptor ring for reuse.

18. The method of claim 16, wherein the packet descriptor ring of the ATM-Ethernet processor is hardware scalable in size.

19. The method of claim 16, wherein the packet descriptor ring is implemented in the ATM-Ethernet processor as a circular FIFO.

20. The method of claim 16, wherein the packet descriptor contains 8 bytes.
